(19) United States
(12) Patent Application Publication
(10) Pub. No.: US 2005/0120179 A1
(43) Pub. Date: Jun. 2, 2005

(54) Single-version data cache with multiple checkpoint support

(75) Inventors: Haitham H. Akkary, Portland, OR (US); Ravi Rajwar, Portland, OR (US); Srikanth T. Srinivasan, Portland, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation (a Delaware corporation), Santa Clara, CA (US)

(21) Appl. No.: 10/724,863

(22) Filed: Dec. 2, 2003

(51) Int. Cl. G06F 12/00

(52) U.S. Cl. 711/126; 711/169; 711/144

(57) ABSTRACT

A single-version data cache processes speculative stores using one or more checkpoints.

### BACKGROUND OF THE INVENTION

Some embodiments of the present invention are generally related to microprocessors, and more particularly, to buffering speculative stores.

Modern microprocessors may achieve high frequencies by exposing instruction level parallelism (ILP), when performing out-of-order processing, by concurrently operating upon a large number of instructions, also known as an instruction window.

Large instruction windows may require store queues. The store queues may serve three functions: disambiguating memory addresses, buffering stores until retirement, and forwarding data to dependent load operations. The third operation, also called store-to-load forwarding, may directly impact cycle time. Since a load may depend upon any store in the queue and multiple stores to the same address may simultaneously be present, the circuit which may identify and forward data, can become complex.

Thus, the processor may experience long delays as store queue sizes increase.

### BRIEF DESCRIPTION OF THE DRAWINGS

The invention shall be described with reference to the accompanying figures, wherein:

FIGS. 1-2 illustrate diagrams of store queues with second level circuits, according to embodiments of the present invention;

FIG. 3 illustrates a diagram of the cache block of a checkpoint, according to an embodiment of the present invention;

FIG. 4 illustrates a diagram of a truth table, according to an embodiment of the present invention;

FIGS. 5A, 5B, and 6 illustrate flow diagrams of store queue operations, according to embodiments of the present invention;

FIGS. 7-8 illustrates diagrams of system environments capable of being adapted to perform the operations of the store queue, according to embodiments of the present invention; and

FIG. 9 illustrates a diagram of a computing environment capable of being adapted to perform the operations of the store queue, according to an embodiment of the present invention.

The invention is now described with reference to the accompanying drawings. In the drawings, like reference numbers generally indicate identical, functionally similar, and/or structurally similar elements. The drawing in which an element first appears is generally indicated by the left-most digit(s) in the corresponding reference number.

### DETAILED DESCRIPTION OF PREFERRED EMBODIMENTS

While the present invention is described in terms of the examples below, this is for convenience only and is not intended to limit its application. In fact, after reading the following description, it will be apparent to one of ordinary skill in the art how to implement the following invention in alternative embodiments (e.g., buffering all store operations with more than two levels of hierarchical structure).

Furthermore, while the following description focuses on the recovery of instructions in a microprocessor using a form of an Itanium® Processor Family (IPF) compatible processor or in a Pentium® compatible processor family (both manufactured by Intel® Corporation, Santa Clara, Calif.), it is not intended to limit the application of the present invention. It will be apparent to one skilled in the relevant art how to implement the following invention, where appropriate, in alternative embodiments. For example, the present invention may be applied, alone or in combination, with various microprocessor architectures and their inherent features, such as, but not limited to, complex instruction set (CISC), reduced instruction set (RISC), very long instruction word (VLIW), and explicitly parallel instruction computing (EPIC).

According to embodiments of the present invention, a store queue may have the capacity to buffer all store operations within a very large instruction window. Additionally, a store queue may provide data to any dependent load in the same time as a data cache hit latency. In one embodiment of the present invention, a store queue includes a first level store queue (L1 STQ) coupled with a second level circuit (L2 CT). In another embodiment, a L2 CT may include a speculative data cache for buffering non-committed stores.

In many embodiments of the present invention, the L1 STQ may be utilized as the principle store queue. The L1 STQ may be a small n-entry buffer holding the last n stores in the instruction window. This buffer may be designed as a circular buffer with head and tail pointers. According to some embodiments, when a new store is inserted into the instruction window, an entry may be allocated for the store at the tail of the L1 STQ. The L1 STQ, in order to prevent stalling when it is full, may remove the previous store from the head of the queue to make space for the new store. The previous store may either be moved into a backing L2 CT, according to some embodiments of the present invention, or into a speculative data cache, according to other embodiments of the present invention. The L1 STQ may have the necessary address matching and store select circuit to forward data to any dependent loads.

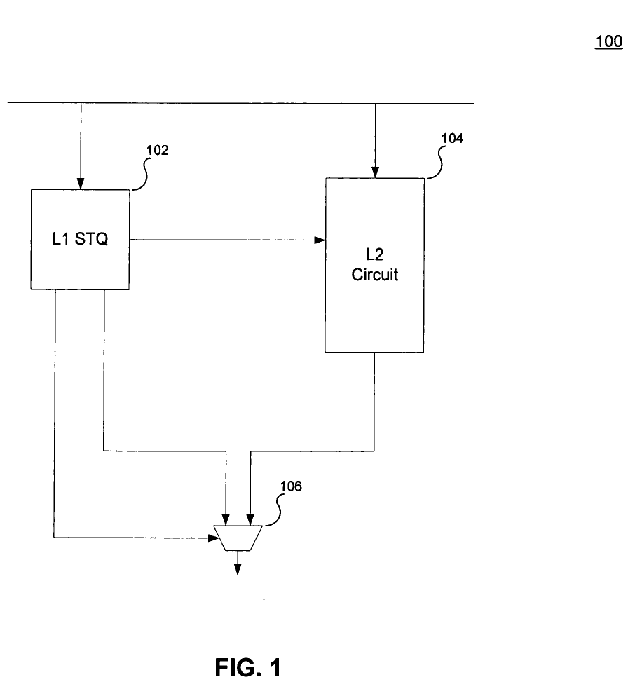

With respect to FIG. 1, a diagram of a store queue with a second level circuit is shown, according to an embodiment of the present invention. In this diagram, hierarchical store queue 100 is shown to include at least, but not limited to, a L1 STQ 102 coupled to a L2 CT 104. Both elements 102 and 104 are capable of receiving stores independently. L2 CT 104 is further capable of receiving stores from the L1 STQ 102. The L1 STQ 102 may include address matching and store select circuit to forward data to any dependent loads. Stores may be processed through multiplexer (MUX) 106, which has selectivity control, as illustrated in the sideways (horizontal) intersecting line from the L1 STQ 102.

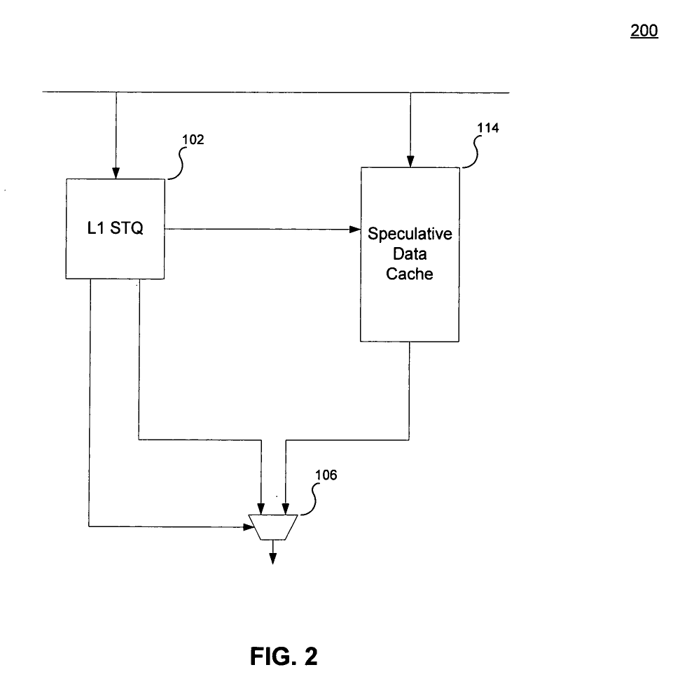

FIG. 2 is an alternative embodiment of the present invention, where the hierarchical store queue 200 includes a speculative data cache, illustrated as element 114. The speculative data cache 114 may be a data cache augmented with support to accept and buffer non-retired store data. According to embodiments of the present invention, this may allow overflows from the L1 STQ 102 to be placed in the speculative data cache 114 without the need of additional store queues. The speculative data cache 114 may differ in design from a non-speculative data cache in that the speculative data cache 114 may provide both 1) management of speculative and committed data simultaneously present in the speculative data cache, and 2) management of multiple store versions to the same address and forwarding the correct store version to a dependent load.

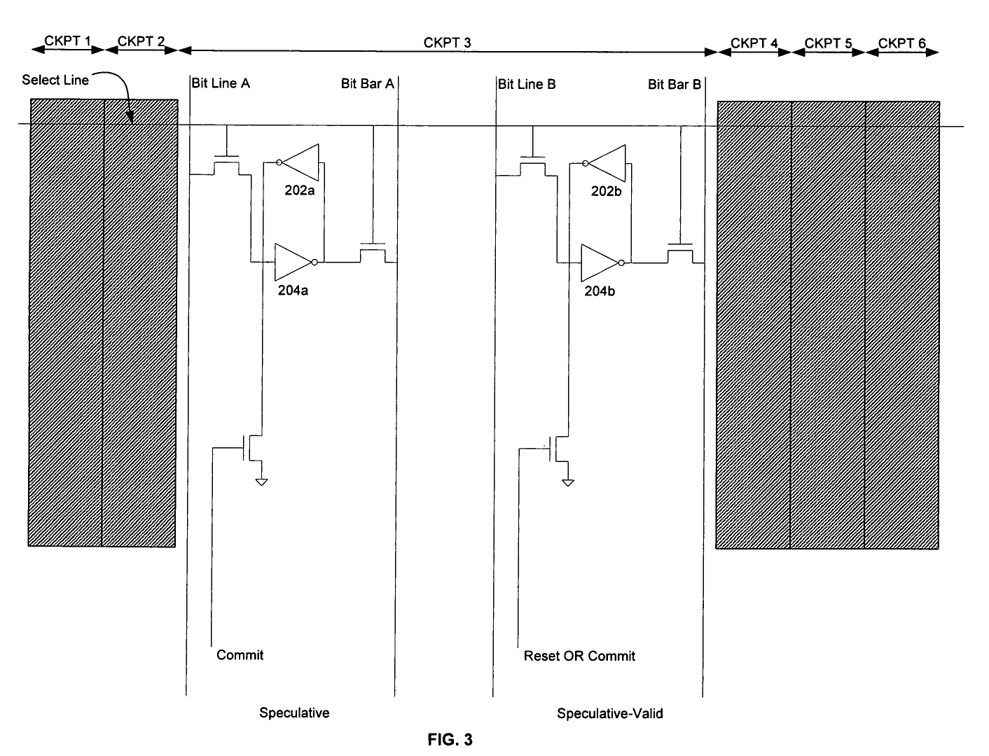

According to one embodiment of the present invention, the management of speculative data may be accomplished using checkpoints with two bits per cache block per checkpoint. The use of two bits per cache block per checkpoint is for exemplary purposes only, and is not intended to limit the scope of the present invention. One of ordinary skill in the relevant arts would recognize, based at least on the teachings provided herein, that additional bits may be provided per cache clock as well as per checkpoint. FIG. 3 illustrates a diagram of the cache block of a checkpoint, according to an embodiment of the present invention, where five checkpoints (CKPT) are shown.

In FIG. 3, CKPT 3 is illustrative of other checkpoints of the present invention, as described above, and illustrates the two bit embodiment of the present invention. A first bit, which may also be called a speculative bit, shown between Bit Line A and Bit Bar A, includes, but is not limited to, three transistors coupled to a pair of inverters 202a and 204a. The first transistor is coupled to a select line, as shown. This bit may indicate if the block is speculative or committed. A second bit, which may also be called a valid bit, shown between Bit Line B and Bit Bar B, includes, but is not limited to, three transistors coupled to a pair of inverters 202b and 204b. This bit may indicate if the speculative block is valid or invalid.

According to one embodiment, the checkpoint may perform various operations, which may include a selective or bulk squash of the stores. To selectively squash the stores in the second level circuit, such as but not limited to L2 CT 104, for a particular checkpoint, for example, in recovering from a branch mispredict, a global clear of valid speculative bits associated with the blocks in the checkpoint may be performed. In order to commit stores associated with a checkpoint; both the speculative bits and the valid bits are cleared for the blocks in this checkpoint.

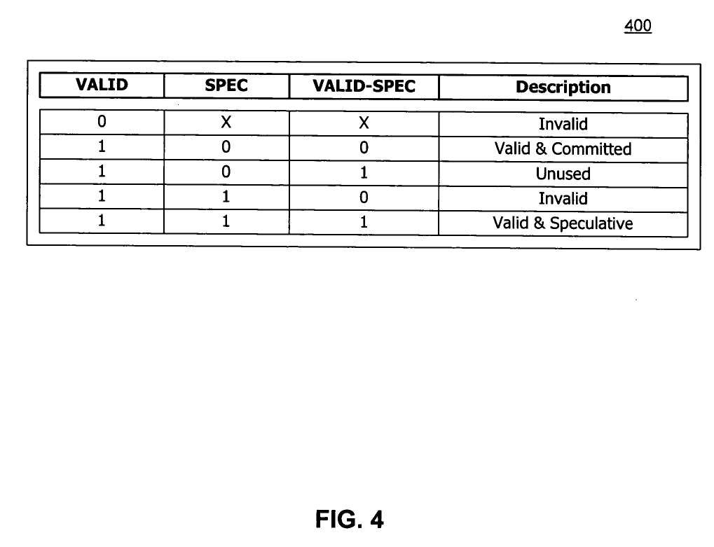

In one embodiment, when a cache block is accessed, the speculative and valid states may be interpreted as shown in FIG. 4, which contains truth table 400. In table 400, the two additional bits are SPEC and VALID-SPEC. The original VALID bit of the cache block may not be used for bulk commit and reset operations without adding complexity to each cell, as this would require conditional logic within the cell. The valid bit may be bulk cleared to invalidate speculative blocks and both the speculative and valid bits are bulk-cleared to commit speculative blocks.

Since the speculative stores would normally update only a few bytes in a block, byte-written bits may be needed to keep track of the updated bytes in the block. When a speculative store misses the L2 CT, a replacement block may be allocated. When a speculative store update hits a L2 CT block in a committed state and the block is in a modified state, the block is evicted before the speculative store is allowed to update the line. If the speculative store hits a speculative block or a committed block which is clean, the new store may be written to the block and the byte-written bits updated accordingly.

In one embodiment, for example purposes only and not intended to limit the scope of the present invention, three memory operations, store one (ST1), load (LD), and store two (ST2) may be considered. ST1 is first in program order followed by LD and then by ST2. Both ST1 and ST2 write the same address and LD reads the same address. As per program order, LD must return the store value of ST1. Since a speculative store may overwrite another speculative store in the L2 CT, and loads may be issued out-of-order, the LD operation accesses the L2 CT after ST2 has overwritten ST1's store value in the L2 CT. This would be a violation of program order.

The present invention provides a solution to this and similar situations, where a rollback may not be required. Speculative stores may be allowed to update the L2 CT, such as the speculative data cache 114, in program order and only after all prior load addresses are known. These stores, however, may not have to wait for branches. Thus, a load may always return data from the correct store as per program order. Additionally, version numbers may not be required to manage individual memory operations.

In one embodiment, a bit per load and store, stored in a circular 1-bit wide buffer, which may be called an unresolved address buffer, may be used to check for non-issued loads ahead of a store. According to the embodiment, the bit is set to 1 when the entry corresponds to a load and the load has been issued to memory. It may also be set to 1, when the entry corresponds to a store and the store address has been computed. In some embodiments, the unresolved address buffer may ensure speculative stores issue to the data cache in-order relative to earlier loads and stores. Loads may continue to issue out-of-order.

According to the above embodiments, the present invention may include a first level store queue 102 adapted to store in an n-entry buffer the last n stores in an instruction window; and a second level circuit 104 adapted to accept and buffer non-retired stores from the first level store queue 102. The first level store queue 102 further includes an address matching circuit; and a store select circuit, where both circuits may forward stores and store data to dependent loads.

As one of ordinary skill in the art would realize, based at least on the teaching provided herein, the first level store queue 102 may be a circular buffer with head and tail pointers.

In additional embodiments, the second level circuit, such as the speculative data cache 114, may include a memory dependence predictor (described further below) which may store in a non-tagged array one or more store-distances, wherein the store-distance may be the number of store queue entries between a load and a forwarding store. The second level circuit may also include an unresolved address buffer adapted to determine a program order condition. The program order condition may include if one or more non-issued load instructions are scheduled ahead of one or more associated store instructions.

The above-described circuit is herein described with respect to an exemplary embodiment involving load and store operations. Alternative and additional embodiments are also described. When a load is issued, and while the L2 CT 104 is being read, the L1 STQ 102 may be accessed in parallel. If the load hits the L1 STQ 102, the store data may not be forwarded to the load. Additionally, if the load misses the L1 STQ 102, and the L2 CT 104 does not have a matching address, the data may be forwarded to the load.

According to some embodiments, a memory dependence predictor (MDP) may be used to identify loads that if allowed to issue in the presence of an unknown address would result in a memory ordering violation and thus, would require re-execution. As processors employing very large instruction windows face an increased misprediction penalty, the MDP may focus on minimizing load-store dependence violations. The following is an example of the MDP, which may be implemented within the L2 CT 104 or within the speculative data cache 114.

In one embodiment of the present invention, the predictor performs operations based upon the notion of a store-distance of a load computed as the number of store queue entries between the load and its forwarding store. To reduce aliasing and allow for forwarding from different instances of the same store at varying store-distances from the load, the L2 CT 104 stores one or more of the store-distances in a non-tagged array that may be indexed by the load instruction address. Thus, based at least on the embodiments described above, a load may be stalled if the distance from a load to a current unresolved store address matches a distance value stored in the array.

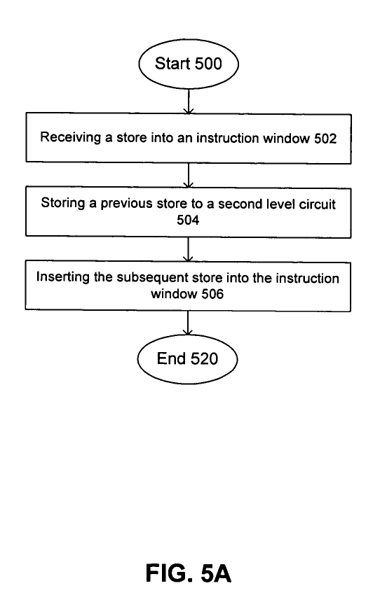

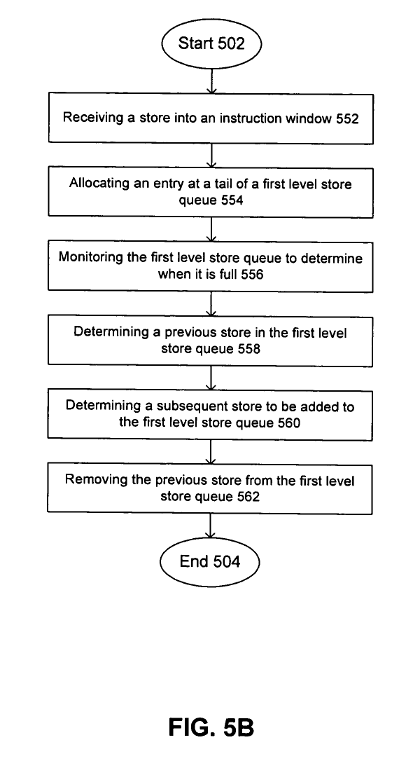

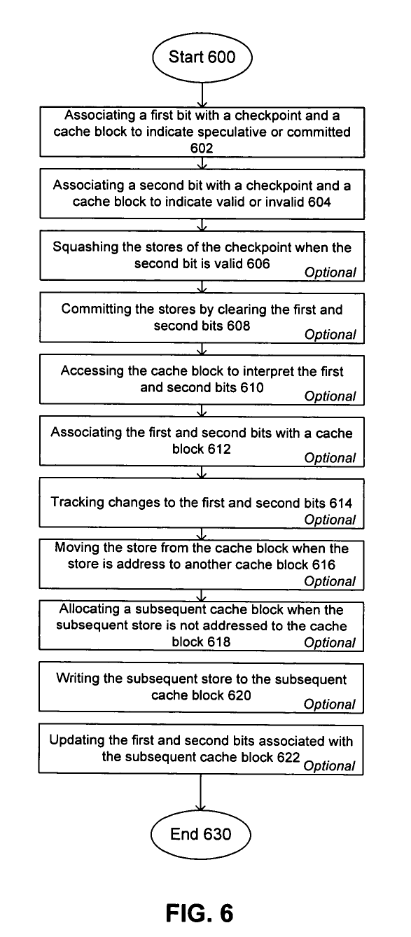

In accordance with the above-described embodiments, the present invention is now illustrated with respect to FIGS. 5A, 5B and 6.

Regarding FIG. 5A, a flow diagram of store queue operation, according to an embodiment of the present invention, is shown. At step 500, the process starts and proceeds to receiving a new store into an instruction window in step 502. The process proceeds to step 504, where it stores a previous store into a second level circuit, where the second level circuit includes at least one block associated with a checkpoint.

By using checkpoints to store architectural states, which may be created at selected points, a means of recovering from branch mispredictions, faults, and other errors is provided. Rather than build and maintain large physical register files, the embodiments of the present invention may make use of checkpoints to track instructions and preserve rename map tables and register files. In embodiments of the present invention, checkpoints may redirect fetch to the correct instruction and restoring the rename map before new instructions reach the rename stage. The map table may be restored from a checkpoint. It may also be incrementally restored from a non-speculative map table such as a retirement register alias table. It may also be incrementally restored from a history buffer that stores the speculative map table updates performed since the mispredicted branch was dispatched. The checkpoints may be generated to enable a restart from a previous architectural state by including copies of the rename map tables or register files such that they may be restored to their previous states.

The storing may place the first level store queue in an n−1 entry state, and allows room for the inserting of the subsequent store into the instruction window at step 506. The process then terminates at step 520, where the process is available to operate again from step 500.

FIG. 5B illustrates an alternative embodiment of step 502, which may, at step 552, receive a new store as in step 502, and then proceeds to step 554, where it allocates an entry at a tail of a first level store queue, and on to step 556, where it monitors the first level store queue. The monitoring of step 556 may include determining when the first level store queue is full. As described elsewhere herein, the first level store queue is designed hold n stores as it provides a buffer for the processor. Once it reaches the n entry limit, the process proceeds to step 558 by determining a previous store from a head of the first level store queue, and then to step 560, where it determines a subsequent store, where the subsequent store needs to be inserted into the instruction window.

With these stores determined, the process can proceed to step 562 and remove the previous store from the head of the first level store queue. As one of ordinary skill in the art would recognize, based at least on the teachings described herein, the process of FIGS. 5A and 5B may be operated in multiple instances in a processor or apparatus having multiple pairs of first level store queues and second level circuits.

In FIG. 6, a flow diagram of store queue operation, according to another embodiment of the present invention, is shown. At step 600, the process starts and, in step 602, associates a first bit with a checkpoint and a cache block in the second level circuit, wherein the first bit indicates if the cache block is speculative or committed. The process then proceeds to step 604, and associates a second bit with the checkpoint and the cache block in the second level circuit, wherein the second bit indicates if the cache block is valid or invalid. FIG. 2 illustrates one embodiment of the store queue usage of the first and second bits.

Once the first and second bits have been associated and their state established, the process has the ability to perform various store queue operations by referring to them. In step 606, the process may squash, either selectively or in bulk, the stores associated with the checkpoint in the second level circuit by clearing the second bit, where the second bit is valid. Furthermore, in step 608, the process may commit one or more stores associated with the checkpoint by clearing the first and second bits in the cache block associated with the checkpoint.

According to some embodiments of the present invention, the process may also perform more complex store queue operations, such as those illustrated in steps 610-614. In step 610, the process may access the cache block to interpret the first and second bits for valid and/or speculative states; proceed to step 612, where it may associate one or more of the first and second bits with a cache block; and finally, in step 614, the process may track changes to the one or more of the first and second bits in the cache block.

According to still other embodiments of the present invention, the process may also perform store optional store queue operations, such as those illustrated in steps 616-622. In step 616, upon completion of step 614, the process may move the store from the cache block when the subsequent store is addressed to the cache block. Alternatively, in step 618, upon completion of step 614, the process may allocate a subsequent cache block when the subsequent store is not addressed to the cache block. The process may then proceed to step 620, and may write the subsequent store to the subsequent cache block; and, in step 622, may update the one or more of said the and second bits associated with the subsequent cache block.

In this detailed description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In this detailed description and claims, the term “coupled,” along with its derivatives, may be used. It should be understood that “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

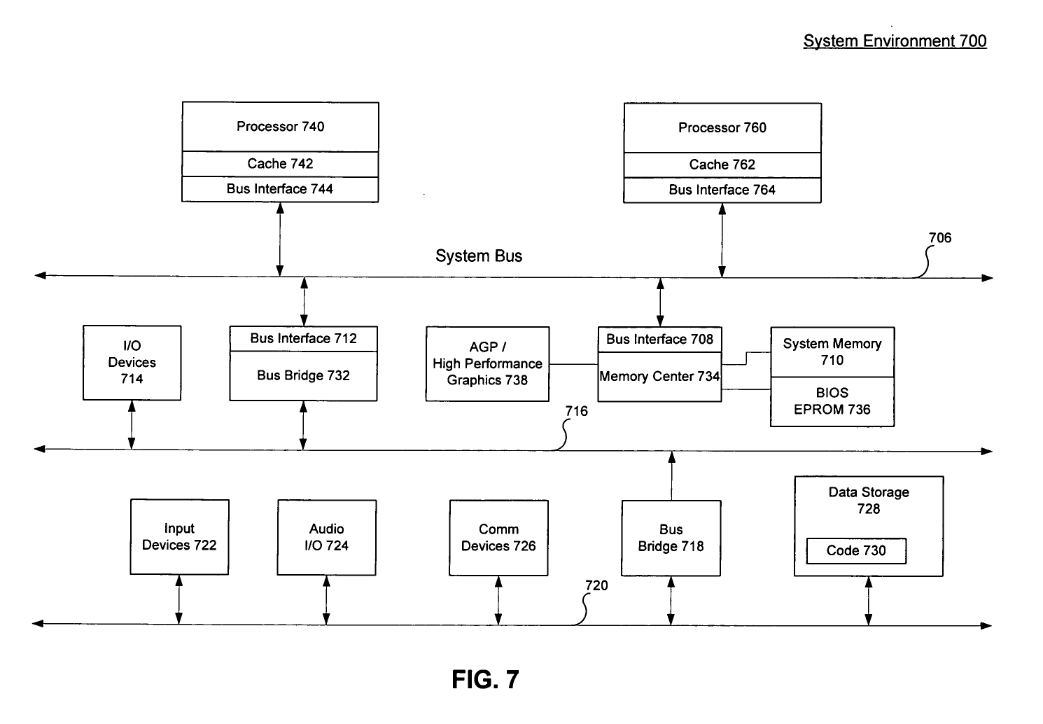

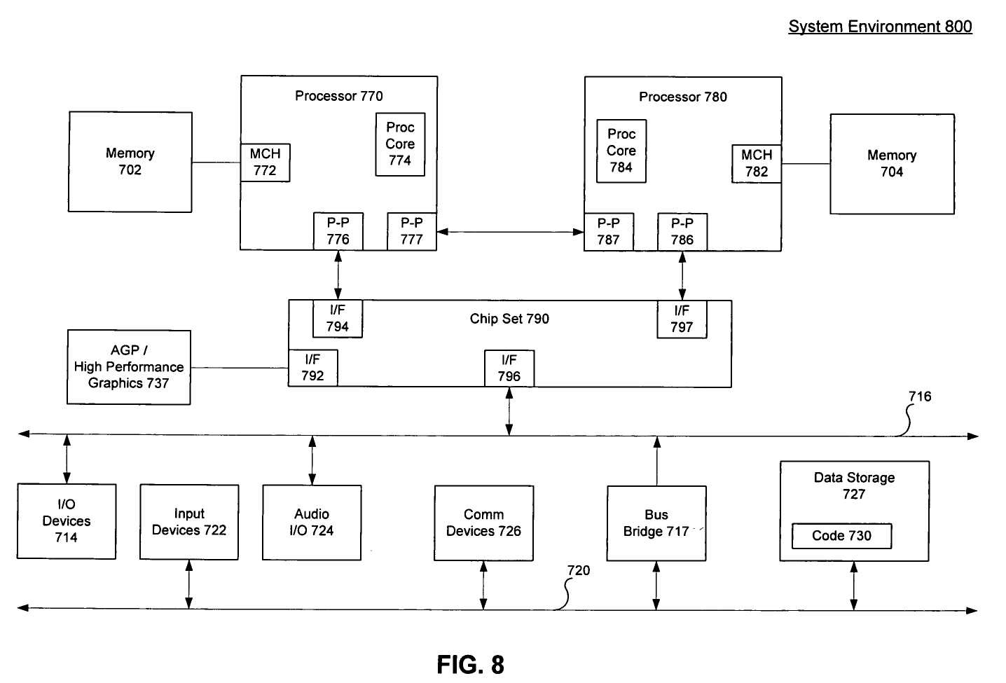

Specifically, and only by way of example, the present invention (i.e., the processes of FIGS. 5-6 and the components of FIGS. 1-4 or any part thereof) may be implemented using one or more microprocessor architectures or a combination thereof and may be implemented with one or more memory hierarchies. In fact, in one embodiment, the invention may be directed toward one or more processor environments capable of carrying out the functionality described herein. An example of system environments 700 and 800 are shown in FIGS. 7 and 8 and include one or more central processing units, memory units, and buses. The system environments 700 and 800 may include a core logic system chip set that connects a microprocessor to a computing system. Various microprocessor architecture embodiments are described in terms of these exemplary micro-processing and system environments. After reading this description, it will become apparent to a person of ordinary skill in the art how to implement the invention using other micro-processing and/or system environments, based at least on the teachings provided herein.

Referring now to FIGS. 7 and 8, schematic diagrams of systems including a processor supporting store queue operations are shown, according to two embodiments of the present invention. The system environment 700 generally shows a system where processors, memory, and input/output devices may be interconnected by a system bus, whereas the system environment 800 generally shows a system where processors, memory, and input/output devices may be interconnected by a number of point-to-point interfaces.

The system environment 700 may include several processors, of which only two, processors 740, 760 are shown for clarity. Processors 740, 760 may include level one (L1) caches 742, 762. The system environment 700 may have several functions connected via bus interfaces 744, 764, 712, 708 with a system bus 706. In one embodiment, system bus 706 may be the front side bus (FSB) utilized with Pentium® class microprocessors. In other embodiments, other busses may be used. In some embodiments memory controller 734 and bus bridge 732 may collectively be referred to as a chip set. In some embodiments, functions of a chipset may be divided among physical chips differently from the manner shown in the system environment 700.

Memory controller 734 may permit processors 740, 760 to read and write from system memory 710 and/or from a basic input/output system (BIOS) erasable programmable read-only memory (EPROM) 736. In some embodiments BIOS EPROM 736 may utilize flash memory. Memory controller 734 may include a bus interface 708 to permit memory read and write data to be carried to and from bus agents on system bus 706. Memory controller 734 may also connect with a high-performance graphics circuit 738 across a high-performance graphics interface 739. In certain embodiments the high-performance graphics interface 739 may be an advanced graphics port (AGP) interface. Memory controller 734 may direct read data from system memory 710 to the high-performance graphics circuit 738 across high-performance graphics interface 739.

The system environment 800 may also include several processors, of which only two, processors 770, 780 are shown for clarity. Processors 770, 780 may each include a local memory channel hub (MCH) 772, 782 to connect with memory 702, 704. Processors 770, 780 may exchange data via a point-to-point interface 750 using point-to-point interface circuits 778, 788. Processors 770, 780 may each exchange data with a chipset 790 via individual point-to-point interfaces 752, 754 using point to point interface circuits 776, 794, 786, 798. Chipset 790 may also exchange data with a high-performance graphics circuit 738 via a high-performance graphics interface 792.

In the system environment 700, bus bridge 732 may permit data exchanges between system bus 706 and bus 716, which may in some embodiments be a industry standard architecture (ISA) bus or a peripheral component interconnect (PCI) bus. In the system environment 800, chipset 790 may exchange data with a bus 716 via a bus interface 796. In either system, there may be various input/output I/O devices 714 on the bus 716, including in some embodiments low performance graphics controllers, video controllers, and networking controllers. Another bus bridge 718 may in some embodiments be used to permit data exchanges between bus 716 and bus 720. Bus 720 may in some embodiments be a small computer system interface (SCSI) bus, integrated drive electronics (IDE) bus, or universal serial bus (USB) bus. Additional I/O devices may be connected with bus 720. These may include input devices 722, which may include, but are not limited to, keyboards, pointing devices, and mice, audio I/O 724, communications devices 726, including modems and network interfaces, and data storage devices 728. Software code 730 may be stored on data storage device 728. In some embodiments, data storage device 728 may be, for example, but is not limited to, a fixed magnetic disk, a floppy disk drive, an optical disk drive, a magneto-optical disk drive, a magnetic tape, or non-volatile memory including flash memory.

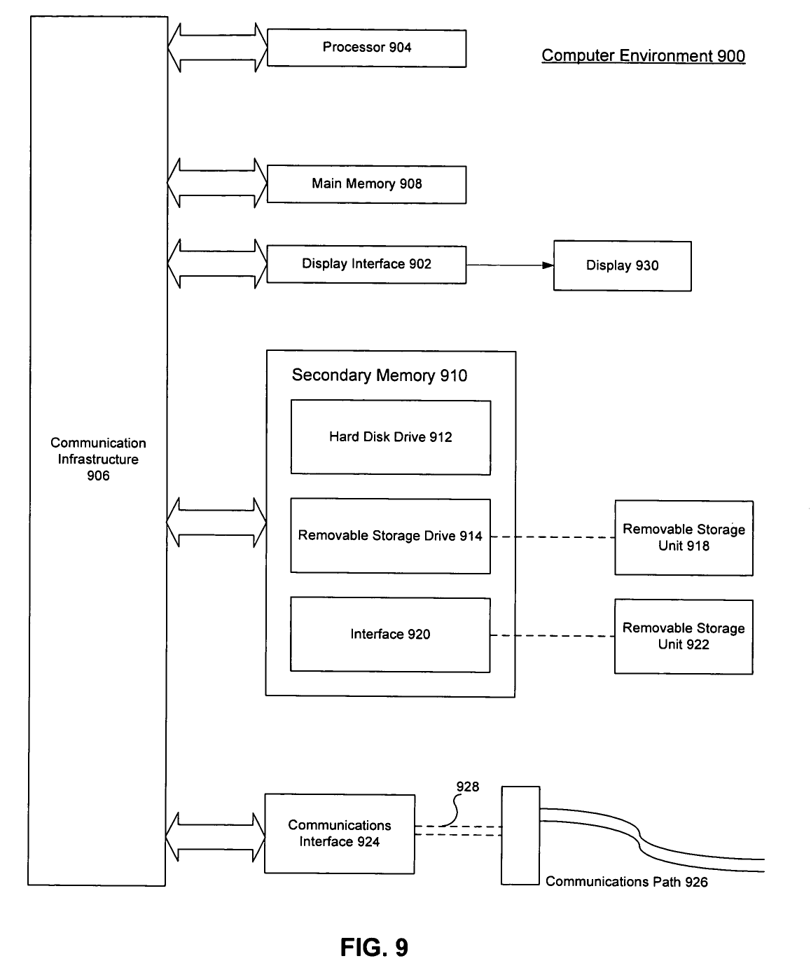

The present invention (i.e., the store queues and store queue operations or any part thereof) may be implemented using hardware, software or a combination thereof and may be implemented in one or more computer systems or other processing systems. In fact, in one embodiment, the invention may comprise one or more computer systems capable of carrying out the functionality described herein. An example of a computer system 900 is shown in FIG. 9. The computer system 900 may include one or more processors, such as processor 904. The processor 904 may be connected to a communication infrastructure 906 (e.g., a communications bus, cross over bar, or network). Various software embodiments are described in terms of this exemplary computer system. After reading this description, it will become apparent to a person skilled in the relevant art(s) how to implement the invention using other computer systems and/or computer architectures.

Computer system 900 may include a display interface 902 that may forward graphics, text, and other data from the communication infrastructure 906 (or from a frame buffer not shown) for display on the display unit 930.

Computer system 900 may also include a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc, but which is not limited thereto. The removable storage drive 914 may read from and/or write to a removable storage unit 918 in a well known manner. Removable storage unit 918, may represent a floppy disk, magnetic tape, optical disk, etc. which may be read by and written to by removable storage drive 914. As will be appreciated, the removable storage unit 918 may include a computer usable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include, but are not limited to, a program cartridge and cartridge interface (such as that found in video game devices), a removable memory chip (such as an EPROM, or PROM) and associated socket, and/or other removable storage units 922 and interfaces 920 that may allow software and data to be transferred from the removable storage unit 922 to computer system 900.

Computer system 900 may also include a communications interface 924. Communications interface 924 may allow software and data to be transferred between computer system 900 and external devices. Examples of communications interface 924 may include, but are not limited to, a modem, a network interface (such as an Ethernet card), a communications port, a PCMCIA slot and card, etc. Software and data transferred via communications interface 924 are in the form of signals 928 which may be, for example, electronic, electromagnetic, optical or other signals capable of being received by communications interface 924. These signals 928 may be provided to communications interface 924 via a communications path (i.e., channel) 926. This channel 926 may carry signals 928 and may be implemented using wire or cable, fiber optics, a phone line, a cellular phone link, an RF link and/or other communications channels.

In this document, the terms “computer program medium” and “computer usable medium” are used to generally refer to media such as, but not limited to, removable storage drive 914, a hard disk installed in hard disk drive 912, and signals 928. These computer program media are means for providing software to computer system 900.

Computer programs (also called computer control logic) may be stored in main memory 908 and/or secondary memory 910. Computer programs may also be received via communications interface 924. Such computer programs, when executed, enable the computer system 900 to perform the features of the present invention as discussed herein. In particular, the computer programs, when executed, may enable the processor 904 to perform the present invention in accordance with the above-described embodiments. Accordingly, such computer programs represent controllers of the computer system 900.

In an embodiment where the invention is implemented using software, the software may be stored in a computer program product and loaded into computer system 900 using, for example, removable storage drive 914, hard drive 912 or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). As discussed above, the invention is implemented using any combination of hardware, firmware and software.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above described exemplary embodiments, but should be defined only in accordance with the following claims and their equivalents.

1. A method, comprising:
receiving a new store into an instruction window;
storing a previous store into a second level circuit, wherein said second level circuit includes at least one block associated with a checkpoint; and
inserting a subsequent store into said instruction window.

2. The method of claim 1, said receiving a new store further compromising:
allocating an entry at a tail of a first level store queue;
monitoring said first level store queue, wherein said monitoring includes determining when said first level store queue is full;
determining a previous store from a head of said first level store queue;
determining a subsequent store, wherein said subsequent store needs to be inserted into said instruction window; and
removing said previous store from said head of said first level store queue.

3. The method of claim 1, further comprising:
associating a speculative bit with said checkpoint and a cache block in said second level circuit, wherein said speculative bit indicates if said cache block is speculative or committed.

4. The method of claim 1, further comprising:
associating a valid bit with said checkpoint and a cache block in said second level circuit, wherein said valid bit indicates if said cache block is valid or invalid.

5. The method of claim 3, further comprising:
associating a valid bit with said checkpoint and a cache block in said second level circuit, wherein said valid bit indicates if said cache block is valid or invalid.

6. The method of claim 5, further comprising:
squashing said stores associated with said checkpoint in said second level circuit by clearing said valid bit, wherein said valid bit is valid.

7. The method of claim 5, further comprising:
committing one or more stores associated with said checkpoint by clearing said speculative and valid bits in said cache block associated with said checkpoint.

8. The method of claim 5, further comprising:
accessing said cache block to interpret said speculative and valid bits for speculative and/or valid states;
associating one or more of said speculative and valid bits with a cache block; and
tracking changes to said one or more of said speculative and valid bits in said cache block.

9. The method of claim 8, further comprising:
moving said store from said cache block to provide space for said subsequent store, when said subsequent store is addressed to said cache block.

10. The method of claim 8, further comprising:
allocating a subsequent cache block when said subsequent store is not addressed to said cache block;
writing said subsequent store to said subsequent cache block; and
updating said one or more of said first and second bits associated with said subsequent cache block.

11. An apparatus, comprising:
a first level store queue adapted to store in an n-entry buffer the last n stores in an instruction window; and
a second level circuit adapted to receive and store non-retired stores from said first level store queue, wherein said second level circuit includes at least one block associated with a checkpoint.

12. The apparatus of claim 11, wherein said second level circuit further comprises:
an address matching circuit; and
a store select circuit, wherein both of said address matching circuit and said store select circuit are adapted to forward stores and store data to any dependent loads.

13. The apparatus of claim 11, wherein said n-entry buffer is a circular buffer with head and tail pointers.

14. The apparatus of claim 11, wherein said second level circuit further comprises:
a memory dependence predictor adapted to store in a non-tagged array one or more store-distances, wherein said store-distance includes the number of store queue entries between a load and a forwarding store.

15. The apparatus of claim 11, wherein said second level circuit further comprises:
an unresolved address buffer adapted to determine a program order condition, wherein said program order condition includes if one or more non-issued load instructions are scheduled ahead of one or more associated store instructions.

16. The apparatus of claim 11, wherein said second level circuit comprises:
a speculative data cache.

17. A system, comprising:
a processor including a first level store queue adapted to store in an n-entry buffer the last n stores in an instruction window, and a second level circuit adapted to receive and store non-retired stores from said first level store queue, wherein said second level circuit includes at least one block associated with a checkpoint;
an interface to couple said processor to input-output devices; and
a data storage coupled to said interface to receive code from said processor.

18. The system of claim 17, wherein said second level circuit further comprises:
an address matching circuit; and
a store select circuit, wherein both of said address matching circuit and said store select circuit are adapted to forward stores and store data to any dependent loads.

19. The system of claim 17, wherein said n-entry buffer is a circular buffer with head and tail pointers.

20. The system of claim 17, wherein said second level circuit further comprises:
a memory dependence predictor adapted to store in a non-tagged array one or more store-distances, wherein said store-distance includes the number of store queue entries between a load and a forwarding store.

21. The system of claim 17, wherein said second level circuit further comprises:
an unresolved address buffer adapted to determine a program order condition, wherein said program order condition includes if one or more non-issued load instructions are scheduled ahead of one or more associated store instructions.

22. The system of claim 17, wherein said second level circuit comprises:
a speculative data cache.
